(19) United States
(12) Patent Application Publication
(10) Pub. No.: US 2021/0381218 A1
(43) Pub. Date: Dec. 9, 2021

(54) Sewer Equipment Cleaning Systems

(71) Applicant: Thomas P. Suiter, Littleton, CO (US)

(72) Inventor: Thomas P. Suiter, Littleton, CO (US)

(21) Appl. No.: 17/342,242

(22) Filed: Jun. 8, 2021

Related U.S. Application Data
(60) Provisional application No. 63/035,886, filed on Jun. 8, 2020.

(51) Int. Cl. E03F 9/00; F16L 55/28

(52) U.S. Cl. CPC E03F 9/00; F16L 2101/12; F16L 55/28

(57) ABSTRACT

Sewer equipment cleaning systems and methods of use are described. The sewer equipment cleaning systems may include an additive delivery system having multiple additive tanks and an additive tank pump configured to deliver additive into a wash system residing on a sewer inspection vehicle (SIV). The SIV is typically equipped with an inspection camera and one or more cables connecting the camera to the SIV. The wash system may be used for rinsing contaminants from the camera and cables upon their withdrawal from a sewer system. The additive delivery system can be plumbed into the SIV wash system in order to deliver additives, which may include surfactants or disinfectants, to water from the wash system, without adulterating water in the wash system water tank.

### CROSS-REFERENCE TO RELATED APPLICATION

This U.S. Non-Provisional application claims the benefit of and priority to U.S. Provisional Application No. 63/035,886, filed Jun. 8, 2020, which is incorporated herein by reference in their entirety.

### FIELD OF THE INVENTION

The present invention relates generally to systems and methods for cleaning sewer equipment and for delivering additives to water from water tanks on sewer inspection vehicles. The water-additive mixtures are typically used to wash or disinfect cameras and cables as they are retrieved from sewers.

### BACKGROUND

Sewer imaging devices are often used to observe conditions in sewer systems. The sewer imaging devices typically use a camera to capture one or more images from within a sewer and transmit the images to a remote location, where the image may be viewed or recorded.

The camera is typically coupled to a sewer inspection vehicle (SIV) by one or more cables. The SIV may be referred to as a closed circuit television (CCTV) truck. The one or more cables can include a communications cable configured to transmit data from the camera to the SIV and a tethering cable configured to suspend or restrain the camera within the sewer system, or to withdraw the camera from the sewer system.

The camera is often inserted into the sewer system through an access port. The access port is typically a manhole, a sewer cleanout port, or other opening providing access into the sewer system. After deploying the camera into the sewer system, the one or more cables typically extend from within the sewer system, through the access port, to the SIV.

The cables and camera are typically retrieved from the sewer during or after inspection of the sewer, whereupon the cables can expose personnel and equipment to contamination from sewer contents that accompany the cables as they leave the sewer. The cables are typically stored and transported on SIVs, and contaminated vehicles can transfer contamination to points far removed from the sewer that is the source of the contamination. The contamination can include human or animal excrement, medical waste, blood-borne pathogens, bacteria including antibiotic resistant bacteria, toxins, parasites, and viruses including coronaviruses.

The SIV is typically equipped with a water tank and a water tank pump for delivering water under pressure from the water tank. The water is typically sprayed onto the cables and camera as they are retrieved from the sewer, in order to reduce contamination from the sewer, prior to loading the cables and camera on the SIV. The water can also be sprayed on other contaminated articles, including but not limited to shoes or other clothing worn by SIV operating personnel. The water is sometimes used to rinse contamination from the personnel's skin.

Compositions are sometimes added to the water tanks on SIVs in order impart additional cleaning or disinfecting qualities to the water-composition mixture. The compositions can be referred to as additives. Such compositions can include, but are not limited to, surfactants, antimicrobial agents, and other disinfecting agents. However, such compositions may render water tank contents unsuitable for some purposes, such as operators rinsing contaminants from their skin, particularly on their faces. In some instances, SIV operators are known to keep jugs of clean water available on SIVs for rinsing their hands and faces, because after adding disinfectants or other compositions to the water tank, the water-composition mixture is unsuitable for use on an operator's skin. Under some conditions, it is desirable to increase or decrease the concentration of additives in the water, or change from one additive to another, which can be difficult with current systems.

Fluid delivery systems for adding compositions to water in sewer trucks such as jetter trucks have been devised. Embodiments of such systems are disclosed in U.S. Pat. Nos. 8,926,764 and 10,150,144. However, fluid delivery systems for jetter trucks generally include components that would duplicate components already found on SIVs. Such duplicated components include a water tank, a main water pump, a wash line for delivery of water or cleaning solution, and a hose reel containing the wash line. Accordingly, a device or system for adding compositions to water in an SIV might not include a wash line, main water tank, or water tank pump configured to deliver water from the water tank and would rely on those components already installed on the SIV.

Accordingly, a device or system for adding compositions to water in an SIV without introducing such compositions to the main SIV water tank is needed. In addition, a device or system for varying concentrations of compositions in water from an SIV water tank would be advantageous.

### SUMMARY OF THE INVENTION

Embodiments of a sewer equipment cleaning system according to the present disclosure comprise an additive delivery system installed on an SIV or configured for installation on an SIV. The SIV includes a camera with one or more cables connecting the camera to the SIV. The one or more cables can include a communication cable and a tethering cable. The SIV further includes a wash system comprising a water tank, a water tank pump, and a wash line. The wash system is typically used to rinse contaminants off of the camera and cables during or after withdrawing the camera from within a sewer. The water tank pump is in fluid communication with the water tank and the wash line and is configured to pump water tank contents through the wash line for spraying the contents on the camera and cables. Persons skilled in the art will recognize that “water tanks” on SIVs may contain other liquids, but typically contain aqueous mixtures that are mostly water.

The additive delivery system comprises multiple additive tanks and an additive delivery pump configured to deliver liquid from one or more of the multiple additive tanks into the fluid path, thereby contributing one or more additives into a liquid stream in the fluid path for delivery of a resulting wash mixture through the wash line. An aqueous mixture including water from the water tank and one or more additives can be referred to as a wash mixture. The additives typically help clean or disinfect the camera and cables. Accordingly, the wash mixture may be more effective at cleaning and disinfecting cables and camera that pain water.

The additive delivery system typically further includes a selector configured to select which of the multiple additive tanks are in fluid communication with the additive delivery pump, and thus which additives are contributed to the fluid path/wash mixture.

The additive delivery system may further include a sensor that detects operation of the water tank pump or fluid flow in the fluid path. Upon detection of water tank pump operation or fluid flow, the sensor signals an additive pump controller that activates the additive delivery pump. Thus, the additive delivery system can be set for automatic activation when the wash system is activated.

In some embodiments the additive delivery system does not include the following components: a water tank, a water tank pump, a wash line, or a reel upon which the wash line is coiled and stored. Because SIVs typically include these components as standard equipment, and because the additive delivery system is typically installed on a SIV as an aftermarket product, the additive delivery system omits these components in order to take advantage of equipment already installed on the SIV.

Even where the additive delivery system is installed on an SIV as optional equipment rather than as an aftermarket product, the additive delivery system is a high-end option that is installed after standard SIV components such as the camera, camera cables, data center, water tank, water tank pump, wash line, and wash line reel.

In some embodiments, a sewer equipment cleaning system can include an additive delivery system and not an SIV.

### BRIEF DESCRIPTION OF THE FIGURES

FIG. 1 shows a sewer equipment cleaning system having an SVI on which is installed an additive delivery system in one embodiment thereof; and

FIG. 2 shows an additive delivery system having a first, second, and third additive tanks in one embodiment thereof.

### DETAILED DESCRIPTION OF THE INVENTION

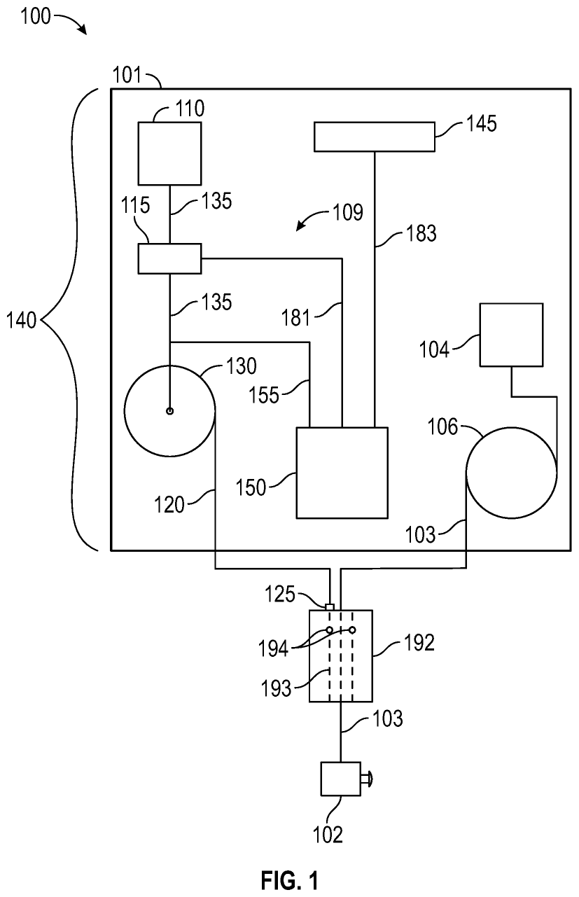

A first embodiment sewer equipment cleaning system 100 comprises an SVI 101 on which is installed an additive delivery system 150, is illustrated in FIG. 1. The SVI comprises a camera 102 coupled to the SVI by one or more cables 103. In use, the camera is typically deployed into a sewer system through a manhole or other access point, while remaining coupled to the SVI by the one or more cables. The one or more cables may include a communication cable for exchanging data between a data center 104 and the camera. The one or more cables may include a tethering cable for withdrawing the camera from within a sewer system. In some embodiments, the communication cable is absent and the camera communicates with the data center by wireless means familiar to persons skilled in the art. In some embodiments, the communication cable also serves as a tethering cable. The SVI may further include a cable reel 106 on which some or all of the one or more cables are stored.

The SVI further comprises a wash system 109 including a water tank 110, a water tank pump 115, and a wash line 120. The water tank pump 115 is in fluid communication with the water tank and is configured to pump water downstream from the water tank to the wash line distal end 125. The SVI wash system 109 may further comprise a hose reel 130 on which some or all of wash line is stored. Wash system plumbing 135 may couple wash system components such as the water tank, the water tank pump, and the wash line together such that they are in fluid communication with each other. A fluid path 140 comprises wash system components downstream from the water tank. The SVI further comprises a generator 145 for generating alternating current (AC) electrical power.

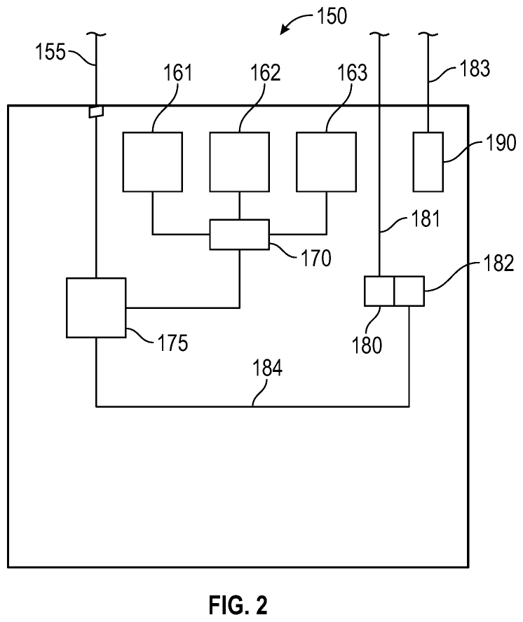

The first embodiment sewer equipment wash system 100 further includes an additive delivery system 150, which is plumbed into the wash system 109 by additive delivery plumbing 155 residing downstream from the water tank pump 115 (i.e., on the “high pressure” side of the wash system). In some embodiments, the additive delivery system can be plumbed into the wash system 109 upstream from the water tank pump (i.e., on the “low pressure” side of the wash system 109). The additive delivery system 150 is illustrated in FIG. 1 with sparse detail and in FIG. 2 in greater detail. The SIV to which the additive delivery system is plumbed and on which it is installed, is not shown in FIG. 2.

As seen in FIG. 2, the additive delivery system 150 includes first, second, and third additive tanks 161, 162, and 163, which can be referred to collectively as multiple additive tanks. Each of the multiple additive tanks are plumbed to an additive selector 170, which is configured to select one or more of the multiple additive tanks for delivery if the one or more tanks contents. An additive delivery pump 175 is plumbed to the additive selector and configured to pump selected additive(s) from the tank to the additive delivery plumbing 155, and subsequently into the wash system 109 (see FIG. 1). The additive delivery pump of the first embodiment may be a diaphragm pump.

In use, each of the multiple additive delivery tanks typically contains a composition that differs in components or concentration from others of the multiple additive delivery tanks. For example, typically the first additive tank 161 contains a first concentration of an antimicrobial composition, and the second additive tank 162 contains a second concentration of the antimicrobial composition, the second concentration being greater than the first concentration. The third additive 163 tank may contain a surfactant that is not present in the first or second tanks, and the antimicrobial composition of the first and second tanks may be absent in the third tank.

The additive delivery system 150 further includes an amperage sensor 180 configured to detect electrical current drawn by the water tank pump 115 on the SIV 101, and an additive pump controller 182 configured to activate the additive delivery pump 175 when the amperage sensor detects electrical current drawn by the water tank pump. A pump control connection 184 between the additive pump controller and the additive delivery pump enables management of pump operation by the controller 182. When the amperage sensor does not detect current drawn by the water tank pump, the additive pump controller stops the additive delivery pump. The amperage sensor 180 includes a sensor connection 181 providing electrical connectivity with the water tank pump 115, in order to detect electrical current drawn by the water tank pump.

The additive delivery system 150 may be configured to have three modes of operation. In a first mode, which can be referred to as AUTOMATIC mode, the additive delivery system operates as described above. When the water tank pump 115 draws current, i.e., when the wash system 109 is operating, the additive delivery pump 175 is automatically activated via the sensor 180 and additive pump controller 182, and compositions from one or more of the multiple additive tanks is delivered into the fluid path 140. When the water tank pump does not draw current, i.e., when the wash system is not operating, the additive delivery pump is idle and the additive delivery system does not deliver compositions from any of the additive tanks.

In a second mode, which can be referred to as ON mode, the additive delivery pump 175 is activated regardless of wash system status (i.e., whether or not the wash system 109 is operating). In the second mode, the amperage sensor 180 does not influence the additive pump controller 182 or the additive delivery pump 175. The second mode may be used, among other things, to prime the additive delivery system 150.

In a third mode, which can be referred to as OFF mode, the additive delivery pump 175 is stopped regardless of wash system status. As with the second mode, in the third mode the amperage sensor 180 does not influence the additive pump controller 182 or the additive delivery pump 175. Off mode can be used where operator of the wash system 109 wishes to deliver water without additives, which can be useful for rinsing a person's skin, face, eyes, etc.

The additive pump controller 182 can be adjusted to control pump speed, typically by varying voltage applied to the additive delivery pump 175. A user may therefore adjust amount of additive delivered to the wash system 109 by varying additive delivery pump speed via the pump controller.

The additive delivery system 150 is typically powered by electrical power from the SIV's generator 145. Electric power is typically delivered through a power cord 183 to the additive delivery system's power supply 190. The power supply may be equipped with one or more converters for converting AC power from the generator 145, to direct current (DC) power for operation of some or all additive delivery system components. For clarity, electrical connections between the power supply and additive delivery system components is not shown.

As seen in FIG. 1, the first embodiment sewer equipment cleaning system 100 further includes a outlet implement 192 coupled to the wash line distal end 125. The outlet implement may be a hose washing assembly described in U.S. patent Ser. No. 10/150,144 (the '144 patent), which is included in the present disclosure as Appendix A. The outlet implement of the first embodiment sewer equipment cleaning system is typically, but not necessarily, substantially similar to the fifth embodiment hose washing assembly, described in the '144 patent, where it is identified by reference character 602.

As shown in FIG. 1, the outlet implement 192 includes a channel 193 through which the cable 103 extends, and spray nozzles 194 in fluid communication with the wash line 120. The spray nozzles are configured to spray water or a wash mixture into the channel, thereby rinsing, cleaning, or disinfecting a section of the cable residing within or proximate the channel.

Other embodiments of outlet implements include, but are not limited to, nozzles, spray guns, valves, spigots, faucets, or other devices configured to control flow or to spray water or a wash mixture discharged from the wash line under positive pressure.

Various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art given the benefit of this disclosure. All variations of the invention that read upon appended claims are intended and contemplated to be within the scope of the invention.

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word's or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment,” “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

The term “sewer,” as used in this specification and appended claims, refers to storm sewers and sanitary sewers familiar to persons skilled in the art.

The term “positive pressure,” as used in this specification and appended claims, refers to pressure above an ambient or atmospheric pressure. Ambient pressure is typically, but not necessarily, about one atmosphere.

Directional or relational terms such as “top,” “bottom,” “upwardly,” “downwardly,” “above,” “below,” “inside,” “outside,” “upper,” and “lower,” as used in this specification and appended claims, refer to relative positions of identified elements, components or objects.

The term “mixture,” as used in this specification and appended claims, refers to a liquid combination of two or more components. The liquid combination can be a solution, heterogeneous blend of multiple components, homogeneous blend of multiple components, emulsion, suspension, or combinations thereof.

The terms “sewer inspection vehicle,” “SIV,” and similar terms, as used in this specification and appended claims, refer to vehicles configured or used to deliver a camera into a sewer system, receive image data from the camera, transmit instructions to the camera, or retrieve the camera from the sewer. SIV's can include trucks and trailers. SIVs typically comprise a camera, a communication cable, and a tethering cable. In some embodiments, the communication cable also serves as the tethering cable, and some embodiments include a tethering cable but not a communication cable, as data is exchanged between the camera and a data center by wireless communication.

The term “antimicrobial,” “antimicrobial substance,” “antimicrobial agent,” “disinfectant,” and similar terms, as used in this specification and appended claims, refers to a substance (or property thereof) that destroys, kills, or inhibits the growth, development, or pathogenic activity of microorganisms. Antimicrobial substances include, but are not limited to, substances having antibacterial or antifungal properties. Soaps and detergents that reduce microorganism abundance merely by reducing adhesion of the microorganisms, in the absence of other antimicrobial action, do not qualify as antimicrobial substances.

1. A sewer equipment cleaning system comprising:
a sewer inspection vehicle (SIV) including:
a water tank;
a water tank pump in fluid communication with the water tank;
a wash line in fluid communication with the water tank pump;
a fluid path including the water tank, the water tank pump, and the wash line;
a camera;
a cable coupling the camera to the SIV; and
an additive delivery system installed on the SIV, the additive delivery system including:
multiple additive tanks;
an additive pump configured to deliver liquid from one or more of the multiple additive tanks to the fluid path;
a selector configured to select which of the additive tanks are in fluid communication with the fluid path;
a sensor configured to detect operation of the water tank pump or fluid flow in the fluid path; and
an additive pump controller configured to activate the additive pump if the sensor detects operation of the water tank pump or fluid flow in the fluid path.

2. The sewer equipment cleaning system of claim 1, further comprising a cable washing device coupled to the wash line.

3. The sewer equipment cleaning system of claim 2, wherein the cable includes a primary cable and a secondary cable, the primary cable being configured to couple the camera to the SIV while the camera resides in a primary sewer line and the secondary cable being configured to couple the camera to the SIV when the camera resides in a secondary sewer line.

4. The sewer equipment cleaning system of claim 2, wherein the additive pump is plumbed into the fluid path between the water tank and the water tank pump.

5. The sewer equipment cleaning system of claim 2, wherein the additive pump is plumbed into the fluid path downstream from the water tank pump.

6. The sewer equipment cleaning system of claim 3, wherein the sensor is an amperage sensor configured to detect electrical current flowing to the water tank pump.

7. A method of making a sewer equipment cleaning system, the method comprising:
providing an additive delivery system, the additive delivery system including: one or more additive tanks;
an additive pump configured to deliver liquid from the one or more additive tanks, wherein the additive delivery system does not include either or both of (i) a pump that is not configured to deliver liquid from the one or more additive tanks, or (ii) a wash line;
a selector configured to select which of the additive tanks are in fluid communication with the additive pump;
a sensor configured to detect operation of the water tank pump or fluid flow in the fluid path; and
an additive pump controller configured to activate the additive pump when the sensor detects operation of the water tank pump or fluid flow in the fluid path;
providing an SIV, the SIV including:
a water tank;
a water tank pump in fluid communication with the water tank;
a wash line in fluid communication with the water tank pump;
a fluid path connecting the water tank, the water tank pump, and the wash line;
a camera; and
a cable coupling the camera to the SIV;
installing the additive delivery system on the SIV, wherein
the additive pump is configured to deliver liquid from one or more of the multiple additive tanks to the fluid path;
the selector is configured to select which of the additive tanks are in fluid communication with the fluid path;
the sensor is configured to detect operation of the water tank pump or fluid flow in the fluid path; and
the additive pump controller is configured to activate the additive pump when the sensor detects operation of the water tank pump or fluid flow in the fluid path.

8. The method of claim 1, further comprising the step of coupling a cable washing device to the wash line.

9. The method of claim 8, wherein the cable includes a primary cable and a secondary cable, the primary cable being configured to couple the camera to the SIV while the camera resides in a primary sewer line and the secondary cable being configured to couple the camera to the SIV when the camera resides in a secondary sewer line.

10. The method of claim 8, wherein the additive pump is plumbed into the fluid path between the water tank and the water tank pump.

11. The method of claim 8, wherein the additive pump is plumbed into the fluid path downstream from the water tank pump.

12. The method of claim 3, wherein the sensor is an amperage sensor configured to detect electrical current flowing to the water tank pump.
